(19) United States
(12) Patent Application Publication
(10) Pub. No.: US 2011/0293780 A1
(43) Pub. Date: Dec. 1, 2011

(54) SYSTEM AND METHOD OF MANUFACTURING A FOOD PRODUCT

(76) Inventors: Joeseph F. Lunzer, Hermosa Beach, CA (US); Morgan J. Blais, Fullerton, CA (US)

(21) Appl. No.: 13/117,957

(22) Filed: May 27, 2011

Related U.S. Application Data
(60) Provisional application No. 61/349,720, filed on May 28, 2010.

(51) Int. Cl. A23C 13/16; A01J 13/00

(52) U.S. Cl. 426/43; 99/456; 99/459

(57) ABSTRACT

A system and method for manufacturing low and non-fat sour cream products is provided. The system may utilize a separation technique to separate liquid whey in cultured milk or fat free milk from the solid matter resulting in light or fat free sour cream. The resulting sour cream has the consistency of sour cream without utilizing additional thickening and emulsifying ingredients. The separation can be accomplished with a plurality of separation techniques including centrifuge, reverse osmosis, ceramic centrifuge and the like.

### PRIORITY CLAIM

This application claims priority to the earlier filed provisional application entitled “System and Method of Manufacturing A Food Product” filed on May 28, 2010 and having U.S. Provisional Application No. 61/349,720.

### FIELD OF THE INVENTION

The field of the invention is for a food product. More specifically, the field of invention is for a system and method for manufacturing a low fat or fat free food product.

### BACKGROUND

Sour cream is a common dairy product sold for food. It is typically made of dairy and is manufactured by allowing the growth of certain types of bacteria (“cultures”) which are either produced naturally, or are introduced into the dairy product and allowed to grow. The dairy product will thicken within time and eventually produce the sour cream product. Sour cream is called by this namesake because it typically has a mild sour taste that occurs from the growth of the bacteria on the dairy product and the production of lactic acid. This process is commonly referred to as souring, thereby giving the product its name.

There are many different varieties of sour cream including natural, regular, light and non-fat types. Generally, natural or regular sour cream is manufactured utilizing whole dairy products including butterfat and it may get its sour taste from the lactic acid created by the bacteria utilized to produce the sour cream. The sour cream products typically have different additives that help with taste, and consistency.

Different types of sour cream include the light and fat free varieties. Light sour cream is manufactured in the same manner as regular full fat sour cream, but utilizes less butterfat, usually incorporating more of one type of dairy product such as milk instead of just cream. Non-fat sour cream further utilizes more milk type products instead of butterfat. However, because light sour cream and non-fat sour cream tend to have a consistency that is much thinner and less “souring” taste, different additives and thickeners must be added to give it the characteristic sour cream taste that is associated with full fat sour creams.

Sour cream is typically made by allowing fresh cream to sour naturally. By allowing it to sour naturally, the acids and bacteria present will produce a general consistent flavor and thick texture that allows for use in a variety of different dishes with a consistent taste and flavor. Most modem manufacturing facilities now produce sour cream by inoculating pasteurized light cream with bacteria cultures, letting the bacteria grow until the cream is both soured and thick, and then re-pasteurizing it to stop the process.

However, to produce low fat or fat free type sour creams, it is necessary to add ingredients such as thickening agents or emulsifiers because the consistency if not uniform and the bacteria growth not sufficient to produce the desired thickness associated with typical sour creams.

Therefore, a need exists for an improved system and method for producing and manufacturing fat free or light sour cream without the necessity to introduce thickening agents or emulsifiers. Moreover, a need exists for an improved system and method for producing and manufacturing fat free or light sour cream by utilizing a separation technique which may allow for separation of the cream from a low fat dairy source.

### SUMMARY OF THE INVENTION

The present invention relates to a system and method for manufacturing low and non-fat sour cream products. The present invention utilizes a separation technique to separate liquid whey in cultured milk or fat free milk from the solid matter resulting in light or fat free sour cream. The resulting sour cream has the consistency of sour cream without utilizing additional thickening and emulsifying ingredients. The separation can be accomplished with a plurality of separation techniques including centrifuge, reverse osmosis, ceramic centrifuge and the like.

To this end in an exemplary embodiment, an improved method and system for producing fat free and low fat sour cream is provided.

In another exemplary embodiment, a method for manufacturing a reduced fat sour cream without introducing thickening agents or emulsifiers, the method comprising: introducing an incoming dairy product to a holding tank; adding a culture to the incoming dairy product to produce a cultured dairy product; separating the cultured dairy product into a liquid and solid matter; and removing the solid matter from a separator.

In another exemplary embodiment, wherein the incoming dairy product comprises skim milk.

In another exemplary embodiment, wherein adding a culture further comprises agitating the cultured dairy product for a first time period to create an agitated cultured product, and then culturing the cultured dairy product by leaving the agitated dairy product undisturbed for a second period of time to create a product.

In another exemplary embodiment, wherein the cultured dairy product is heated to approximately 105° F.

In another exemplary embodiment, wherein the second period of time is determined by an amount of time for the product to reach a pH of approximately 4.6 to 4.5.

In another exemplary embodiment, wherein re-agitating the product for a third period of time to create a re-agitated product; introducing the re-agitated product through a screen and into a separator; and removing the whey from the re-agitated product.

In another exemplary embodiment, wherein the separator is a centrifuge, to separate the solid matter to an exterior of the separator and the liquid to an interior of the separator by rotation of the separator.

In another exemplary embodiment, wherein the incoming dairy product comprises skim milk, and the solid matter as a fat free sour cream without thickeners and emulsifiers.

In another exemplary embodiment, wherein the cultured dairy product is heated to approximately 145° F., and the second period of time is determined by an amount of time for the product to reach a pH of approximately 4.6 to 4.5, and the solid matter comprises a reduced fat sour cream.

In another exemplary embodiment, a method for manufacturing a dairy product, the method comprising: heating skim milk to a temperature of approximately 105° F.; adding cultures to the skim milk to create a cultured product; agitating the cultured product once the cultured product has reached a pH of approximately 4.5 to 4.6 to create an agitated cultured product; and separating the agitated cultured product into a solid matter and a liquid matter through centrifugal separation.

In another exemplary embodiment, wherein separating the agitated cultured product removes whey from the agitated cultured product through a backpressure created by rotation of a separator and removes white mass through an exterior surface of the separator.

In another exemplary embodiment, wherein pasteurizing the skim milk to a temperature of at least approximately 185° F. to create a pasteurized milk; cooling the pasteurized milk to 105° F. before adding the cultures; and agitating the cultured product for a first period of time to create a mixture before leaving the mixture undisturbed for a second period of time.

In another exemplary embodiment, wherein the second period of time is approximately 4 to 6 hours and determined when the mixture reaches a pH of approximately 4.5 to 4.6.

In another exemplary embodiment, wherein the white mass is a reduced fat sour cream without thickeners and emulsifiers having the approximate consistency of sour cream made from a whole dairy product.

In another exemplary embodiment, a system for manufacturing a dairy product, the system comprising: a holding tank for holding incoming dairy product; a culture added to the incoming dairy product; a separation technique for separating the dairy product into a liquid and solid matter; and a removal valve for removing liquid matter from the holding tank.

In another exemplary embodiment, a homogenizer for pasteurizing and homogenizing the incoming dairy product; an agitator for agitating the culture and incoming dairy product; and a exterior holding unit containing solid matter expelled from the holding tank of the system.

In another exemplary embodiment, wherein the separation technique is reverse osmosis.

In another exemplary embodiment, wherein the separation technique is centrifugal separation in which the cultured dairy product is continuously fed into a centrifuge.

In another exemplary embodiment, wherein the separation technique is ceramic filtration.

In another exemplary embodiment, wherein the separation technique is used to produce a fat free sour cream product without additives to thicken the consistency of the product.

In another exemplary embodiment, an improved method and system for producing low fat and fat free sour cream is provided whereby the system utilizes a separation technique.

In an exemplary embodiment, an improved method and system for producing low fat and fat free sour cream is provided whereby the system utilizes a plurality of separation techniques.

In an exemplary embodiment, an improved method and system for producing low fat and/or fat free sour cream is provided whereby the system utilizes a separation technique whereby the separation technique is through centrifugal separation in which the cultured skim milk is continuously fed to a centrifuge.

Still another exemplary embodiment is to provide an improved system and method for producing and manufacturing fat free and/or light sour cream whereby the system may utilize reverse osmosis to produce a liquid whey and resulting a solid matter.

In an exemplary embodiment, a system and method for producing a fat free and/or reduced fat sour cream is provided whereby the system may utilize ceramic filtration to filter a liquid whey product from a solid sour cream product.

Yet another exemplary embodiment is to provide a system and method for producing a fat free and/or reduced fat sour cream product into the system utilizing a centrifugal separation technique to separate the liquid whey product of a skim milk from the solid matter which has been cultured to produce a sour cream product.

In yet another exemplary embodiment, a system and method for producing a fat free and/or reduced fat sour cream product is provided whereby the system utilizes a separation technique which causes the heavier solid matter to flow to the exterior of the separation tank whereby the solid matter is collected and a sour cream product is produced.

In a further exemplary embodiment, a system and method for producing a fat free and/or reduced fat sour cream product is provided whereby the system utilizes a spinning centrifuge in a holding tank containing cultured skim or low fat milk products.

Yet another exemplary embodiment is to provide a system and method for producing a fat free and/or reduced fat sour cream product into the system utilizing a spinning centrifuge which causes the heavier solid matter to flow into a separate holding container, thereby leaving the liquid whey product in the original holding tank which may be utilized in different dairy products.

It is contemplated that another exemplary embodiment is to provide a system and method for producing a fat free and/or reduced fat sour cream product, the system utilizes a separation technique whereby a holding tank containing the cultured dairy product allows for separation of a liquid whey product from a solid sour cream product, whereby the liquid product may be removed from the holding container and more cultured dairy products introduced in a continuous fashion.

Yet another exemplary embodiment is to provide a system and method for producing a fat free and/or reduced fat sour cream product whereby the system does not require the use of a thickening agent.

Still another exemplary embodiment of the present invention is to provide a system and method for producing a fat free and/or reduced fat sour cream product whereby the system does not require the addition of emulsifier agents.

Another exemplary embodiment of the present invention is to provide a system and method for producing a fat free and/or reduced fat sour cream product whereby the system does not require the use of thickening, emulsifying or other additional ingredients to produce the consistency desired in a sour cream product.

In an exemplary embodiment, a system and method for producing a fat free and/or reduced fat sour cream product may be provided whereby the system may be utilized to produce other types of dairy products including yogurt and the like.

In still another exemplary embodiment, a system and method for producing a fat free and/or reduced fat sour cream product is provided whereby the system may be utilized for other types of dairy products including cream cheese and the like.

Various objects, features, aspects and advantages of the present invention will become more apparent from the following detailed description of preferred embodiments of the invention, along with the accompanying drawings in which like numerals represent like components.

### DESCRIPTION OF THE DRAWINGS

The drawings refer to embodiments of the invention in which:

FIG. 1 illustrates an exemplary block diagram of an exemplary process to produce low fat and non-fat dairy products;

FIG. 2 illustrates an exemplary block diagram of the system to perform the exemplary process of FIG. 1; and

FIG. 3 illustrates an exemplary separator for use in the above processes.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

The present invention provides a method for producing fat free sour cream through separation of liquid whey in cultured milk or fat free milk from the solid matter resulting in light or fat free sour cream. The resulting sour cream has the consistency of sour cream without utilizing any ingredients designed to thicken or emulsify. The separation technique utilizes centrifugal separation, in which the cultured skim milk is continuously fed to a centrifuge. The spinning centrifuge causes the heavier solid matter to flow to the exterior of the unit where it can be pulled off. The liquid component is removed from the interior of the separator as more product is fed in. “Solid matter” is intended to encompass proteins and solids from the milk that form the gelatinous material of sour cream or other desired product not including the whey.

Although embodiments of the invention may be described and illustrated herein in terms of manufacturing light or fat free sour cream, it should be understood that embodiments of this invention are not so limited, but are additionally applicable to manufacturing yogurt, cream cheese, Quark, and other low fat dairy products. Furthermore, although embodiments of the invention may be described and illustrated herein in terms of centrifugal separation, it should be understood that embodiments of the invention may also utilize other forms of separation, such as reverse osmosis and ceramic filtration.

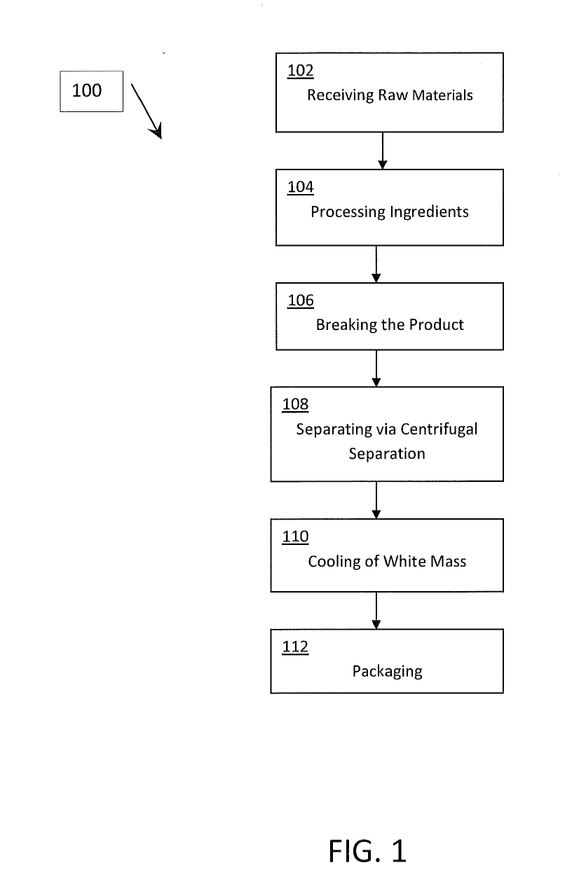

FIG. 1 illustrates an exemplary manufacturing process 100 for fat free or light sour cream using a separation technique. The ingredients for the sour cream are received and processed at the plant. The processed ingredients are then broken and separated through centrifugal separation. Finally, the white mass is cooled and pulled from the assembly to be packaged, sealed, refrigerated, and shipped for distribution.

First, step 102, the ingredients are received. The milk may be received from any distribution source, and received in the facility in a number of ways and stored. For example, skim milk is received at the facility via bulk tanker and pumped into refrigerated storage tanks using a centrifugal pump.

Then, step 104, the ingredients are processed. The ingredients are pasteurized by any means known in the art. The pasteurization may occur at the sour cream processing plant, or may be performed separately before the ingredients are received at the plant. For example, a High Temperature, Short Time pasteurizer may be used. The pasteurizer will take the temperature of the ingredients to 162° F. to 197° F., and preferably 185° F. for approximately 6 minutes and then cooled to a desired temperature culturing and for creating desired resultant product. For fat free sour cream, the desired temperature is approximately 105° F., but may be between 103° F. and 110° F., and preferably 105° F. to 108° F. For light sour cream, the desired temperature is approximately 145° F., with a similar margin of error. Live cultures are then added and agitated for 20 minutes once all the skim milk has been processed. For manufacturing sour cream, the culture may include CH Hansen DSG2000-10: DSG2000-40 Flavor 1, although other cultures may also be used. Once agitation has taken place for approximately 20 minutes, the agitation is turned off and the product will culture for 4 to 6 hours undisturbed.

Next, step 106, the product is broken. Once reaching a pH of 4.6 to 4.5, agitation is reinitiated and after approximately 15 minutes the mixture will degassed for approximately 30 minutes or more, while continuously being agitated. Degassing removes the suspended gases in the mixture, including carbon dioxide.

Step 108, the mixture is separated via centrifugal separation. The mixture is then separated into a liquid component and a solid mass. Before separation, the mixture may be filtered by passing through screens to break up and smooth the proteins, fat, and general solids in the cultured fluid. This reduces the potential to clog the separator and conditions the product to produce a more consistent white mass. For example, the mixture is pulled from the degas tank and pushed through micro screens. The filtered mixture continues to flow into the top of the separator while keeping a constant flow of liquid supplying the separator. Essentially, the separator rotates to cause the heavier solid matter to flow to the exterior of the unit where it can be pulled off, while the liquid component, whey, is removed from the interior of the separator.

Step 110, the solid matter, or white mass, is cooled. From the solid mass collector of the separator, the white mass is sent through a chiller. The product is then cooled from the desired separation temperature, e.g. approximately 105° F. for fat free sour cream or 145° F. for light sour cream, down to approximately 65° F. and transferred to a finish tank where it will sustain a temperature of 65° F. or below, and preferably below 60° F. or even 40° F.

Finally, step 112, the product is packaged. White mass is pulled from the finish tank, which then pushes the white mass to a filler of choice. The white mass is packaged, sealed, packed, and placed in refrigerated storage of approximately 35° F. to 40° F. until shipping to a final destination.

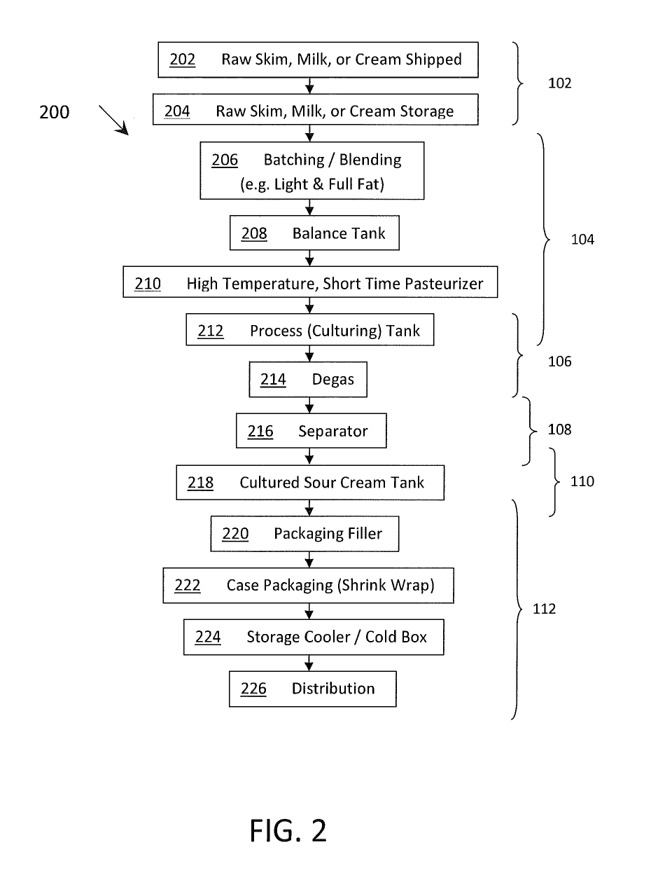

FIG. 2 illustrates an exemplary block diagram of a system for carrying out the process of FIG. 1. The exemplary system and processes of FIGS. 1 and 2 are illustrative only, and as would be understood to a person of skill in the art, may be combined, rearranged, and separated to include more or less steps and associated components. As will be seen in FIG. 2, the process may be modified depending on the desired output product, e.g. fat free, light, or fully fat sour cream. FIG. 2 follows generally the manufacturing process of FIG. 1, including receiving the raw materials 102, processing the ingredients 104, breaking the product 106, separating 108, cooling the white mass 110, and packaging 112 for distribution.

First, step 102, the ingredients are received. This may include one or more components or processes to accomplish. For example, 202, a tanker may be used to transport the desired ingredients, including raw skim milk, whole milk, reduced fat milk, or cream. Once received, the ingredients may be stored in refrigerated storage tanks, 204. Pumps may be used to transport the ingredients from the tankers to the storage trucks.

Then, step 104, the ingredients are processed. Here, the ingredients may be mixed depending upon the desired resulting product. For example, reduced fat, whole milk, and/or cream may be mixed at desired proportions to create either a reduced fat or whole fat sour cream. A batch or blending tank 206 may be used to facilitate the processing. However, if fat free sour cream is made, skim milk may be the only desired base ingredient, and the blending tank 206 may be removed from the system. The ingredients are pasteurized by any means known in the art. For example, the ingredients may be drawn from the storage tank using a centrifugal pump that will pull the milk into a High Temperature, Short Time pasteurizer's balance tank 208. The milk will then be homogenized at 1500 pounds per square inch in a single or dual stage homogenizer 210. The homogenizer 210 includes heaters and coolers to create the desired temperatures for pasteurization (e.g. 185° F.) and culturing (e.g. 105° F. or 145° F.). The pasteurized mixture is then directed to a culturing tank 212 where live cultures are added. The culturing tank may include sweep agitators to mix the ingredients and cultures. The culturing tank may also include heaters to maintain the desired temperature during the growth process.

Next, step 106, the product is broken. After maintaining a pH of 4.6 to 4.5 and re-agitating the mixture, the mixture may be transferred to a degas tank via centrifugal pump. The degas tank may similarly include sweep agitators for continuously mixing the material in the tank.

Step 108, the mixture is separated via centrifugal separation. Using a centrifugal pump, the mixture may be pulled from the degas tank 214 and pushed through microscreens. The microscreens may be 40 microscreens to remove oversized solids, and break up and smooth the remaining proteins, fats, and general solids from the cultured mixture. The filtered mixture continues to flow into the top of the separator 216 while keeping a constant flow of liquid supplying the separator. Back pressure within the separator forces whey out of the skim milk. Whey is discharged to a balance tank, which is a bi-product of the finished product. The whey is then sent to a storage tank via centrifugal pump. The solid matter, or white mass, is created by forcing the proteins and solids from the skim milk through micro-nozzles in the separator. The white mass then discharges from the separator into a balance tank 218.

Step 110, the solid matter, or white mass, is cooled. From the balance tank 218 of the separator 216, the white mass may be sent through a plate chiller via a positive displacement pump. Other cooling methods may similarly be employed, such as plate and frame, shell and tube, etc. Once cooled, the product is then transferred to a finish tank for holding.

Finally, step 112, the product is packaged. White mass is pulled from the finish tank via a positive displacement pump, which then pushes the white mass to a filler of choice 220. The white mass is packaged 222, sealed, packed, and placed in refrigerated storage 224 of approximately 35° F. to 40° F. until shipping 226 to a final destination.

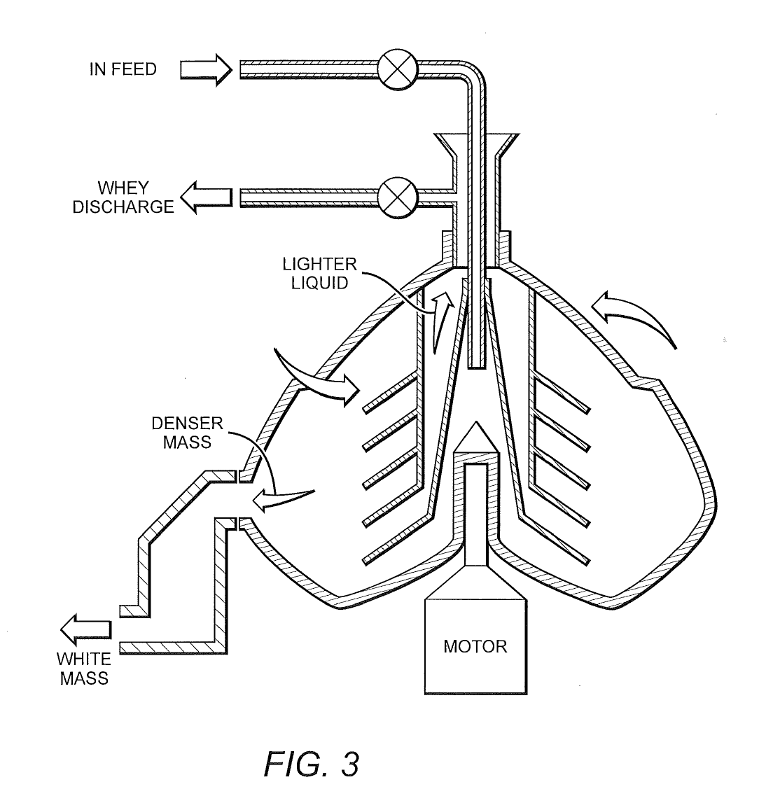

FIG. 3 illustrates an exemplary separator for use as the centrifugal separation technique described above. The separator 300 rotates to move the solid mass out nozzles; on an exterior surface of the separator, while the liquid is brought to the interior of the separator and removed out a top portion through back pressure created during separation. Various sized nozzles may be used for the solid mass removal, depending on the flow rate desired. For example, a nozzle with a 0.7 mm opening may be used as the conduit for the removed solid mass from the separator. The liquid discharge may include a back pressure valve to regulate and maintain the pressure within the separator. Adjusting the pressure or the input/output flow rates change the consistency of the resulting solid product. Preferably, the back pressure is maintained at approximately 60 psig. The separator also includes a motor and drive shaft to rotate the chamber to cause the solid and liquid masses to separate. The separator may rotate at 10,000 revolutions per minute or more. A faster rotation is desired to more fully separate the solid matter from the liquid discharge.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. For example, as described above, a method for manufacturing fat free and light sour cream is described. However, other products may also be made by adapting the present disclosure, such as yogurt. Also, specific procedures, methods, and steps were used to describe the method of manufacture. However, a person of skill in the art would understand that the exemplary method may be modified to add, remove, interchange, combine, and/or separate the various steps into different logical combinations without departing from the inventive concept presented. Also, the disclosed amount of time utilized to reach the various temperatures and pH are exemplary only. Other times may be required depending on the volume of ingredients, the size of the machines, and other processing parameters. Accordingly, all of these variations are considered within the scope of the present invention. As used herein “reduced fat sour cream” is intended to mean a sour cream product of a reduced fat content as compared to a whole fat sour cream. “Reduced fat sour cream” includes non-fat, fat free and light sour cream.

1. A method for manufacturing a reduced fat sour cream without introducing thickening agents or emulsifiers, the method comprising:
introducing an incoming dairy product to a holding tank;
adding a culture to the incoming dairy product to produce a cultured dairy product;
separating the cultured dairy product into a liquid and solid matter; and
removing the solid matter from a separator.

2. The method of claim 1, wherein the incoming dairy product comprises skim milk.

3. The method of claim 1, wherein adding a culture further comprises agitating the cultured dairy product for a first time period to create an agitated cultured product, and then culturing the cultured dairy product by leaving the agitated dairy product undisturbed for a second period of time to create a product.

4. The method of claim 3, wherein the cultured dairy product is heated to approximately 105° F.

5. The method of claim 4, wherein the second period of time is determined by an amount of time for the product to reach a pH of approximately 4.6 to 4.5.

6. The method of claim 5, further comprising:
re-agitating the product for a third period of time to create a re-agitated product;
introducing the re-agitated product through a screen and into a separator; and
removing the whey from the re-agitated product.

7. The method of claim 6, wherein the separator is a centrifuge, to separate the solid matter to an exterior of the separator and the liquid to an interior of the separator by rotation of the separator.

8. The method of claim 7, wherein the incoming dairy product comprises skim milk, and the solid matter as a fat free sour cream without thickeners and emulsifiers.

9. The method of claim 3, wherein the cultured dairy product is heated to approximately 145° F., and the second period of time is determined by an amount of time for the product to reach a pH of approximately 4.6 to 4.5, and the solid matter comprises a reduced fat sour cream.

10. A method for manufacturing a dairy product, the method comprising:
heating skim milk to a temperature of approximately 105° F.;
adding cultures to the skim milk to create a cultured product;
agitating the cultured product once the cultured product has reached a pH of approximately 4.5 to 4.6 to create an agitated cultured product; and
separating the agitated cultured product into a solid matter and a liquid matter through centrifugal separation.

11. The method of claim 10, wherein separating the agitated cultured product removes whey from the agitated cultured product through a backpressure created by rotation of a separator and removes white mass through an exterior surface of the separator.

12. The method of claim 11, further comprising:
pasteurizing the skim milk to a temperature of at least approximately 185° F. to create a pasteurized milk;
cooling the pasteurized milk to 105° F. before adding the cultures; and
agitating the cultured product for a first period of time to create a mixture before leaving the mixture undisturbed for a second period of time.

13. The method of claim 12, wherein the second period of time is approximately 4 to 6 hours and determined when the mixture reaches a pH of approximately 4.5 to 4.6.

14. The method of claim 13, wherein the white mass is a reduced fat sour cream without thickeners and emulsifiers having the approximate consistency of sour cream made from a whole dairy product.

15. A system for manufacturing a dairy product, the system comprising:
a holding tank for holding incoming dairy product;
a culture added to the incoming dairy product;
a separation technique for separating the dairy product into a liquid and solid matter; and
a removal valve for removing liquid matter from the holding tank.

16. The system described in claim 15, further comprising:
a homogenizer for pasteurizing and homogenizing the incoming dairy product;
an agitator for agitating the culture and incoming dairy product; and
a exterior holding unit containing solid matter expelled from the holding tank of the system.

17. The system of claim 15, wherein the separation technique is reverse osmosis.

18. The system of claim 15, wherein the separation technique is centrifugal separation in which the cultured dairy product is continuously fed into a centrifuge.

19. The system of claim 15, wherein the separation technique is ceramic filtration.

20. The system of claim 15, wherein the separation technique is used to produce a fat free sour cream product without additives to thicken the consistency of the product.
